(19) United States
(12) Patent Application Publication
(10) Pub. No.: US 2013/0154966 A1
(43) Pub. Date: Jun. 20, 2013

(54) TOUCH PANEL

(71) Applicants: Youn Soo Kim, Gyunggi-do (KR); Sang Hwan Oh, Gyunggi-do (KR); Ho Joon Park, Gyunggi-do (KR); Hyun Jun Kim, Gyunggi-do (KR)

(72) Inventors: Youn Soo Kim, Gyunggi-do (KR); Sang Hwan Oh, Gyunggi-do (KR); Ho Joon Park, Gyunggi-do (KR); Hyun Jun Kim, Gyunggi-do (KR)

(73) Assignee: SAMSUNG ELECTRO-MECHANICS CO., LTD., Gyunggi-do (KR)

(21) Appl. No.: 13/591,975

(22) Filed: Aug. 22, 2012

(30) Foreign Application Priority Data
Dec. 14, 2011 (KR) 10-2011-0134588

(51) Int. Cl. G06F 3/041

(52) U.S. Cl. 345/173

(57) ABSTRACT

Disclosed herein is a touch panel in which an upper transparent substrate and a lower transparent substrate are adhered to each other such that an upper detecting electrode that is formed on surfaces of convex portions of the upper transparent substrate crosses a lower detecting electrode that is formed in one direction in which concave portions and the convex portions of the lower transparent substrate are formed, and the surfaces of the convex portions on which the upper detecting electrode is formed and the surfaces of the concave portions on which the lower detecting electrode is formed face each other. Thus, a distribution of an electric field is concentrated on a sensing electrode, thereby improving the sensitivity of the touch panel, compared to a general electrode structure.

### CROSS REFERENCE TO RELATED APPLICATION

This application claims the benefit of Korean Patent Application No. 10-2011-0134588, filed on Dec. 14, 2011, entitled “Touch Panel”, which is hereby incorporated by reference in its entirety into this application.

### BACKGROUND OF THE INVENTION

1. Technical Field

The present invention relates to a touch panel.

2. Description of the Related Art

As computers using digital technologies have been developed, auxiliary devices of computers have been developed together. A personal computer, a portable transmitting device, other personal information processing devices, or the like processes texts and graphics by using various input devices such as keyboards and mouths.

By virtue of rapid development of information-oriented society, the use of a computer has been gradually spread. However, it is difficult to effectively drive a product by simply using a keyboard and a mouth that currently serve as an input device. Thus, there is an increasing need for a device for facilitating simple manipulation, preventing wrong manipulation, and allowing anyone to easily input information.

With regard to technologies related to an input device, attention has been changed from technologies for satisfying requirements for general functions to technologies for high reliability, durability, and innovativeness, technologies related to design and process, and the like. To this end, a touch panel has been developed as an input device facilitating an input of information such as a text, a graphic, or the like.

A touch panel is a tool that is installed on a display surface of a flat display device such as an electronic notebook, a liquid crystal display device (LCD), a plasma display panel (PDP), an electroluminescence (El), or the like or a display surface of an image display device such as a cathode ray tube (CRT) and is used when a user selects desired information while viewing an image display device.

A touch panel is classified into a resistive-type touch panel, a capacitive-type touch panel, an electromagnetic-type touch panel, a surface acoustic wave (SAW)-type touch panel, and an infrared-type touch panel. These various types of touch panels are used in electronic products in consideration of a signal amplification issue, a difference in resolutions, a difficulty of design and process technologies, optical properties, electrical properties, mechanical properties, environmental properties, input properties, durability, and economic efficiency. In this regard, a touch panel that has been getting the spotlight in wide fields is a capacitive-type touch panel.

In general, a touch panel has been widely used by virtue of the spread and diversification of functions of a personal digital assistant (PDA). In addition, the scope of the use of a touch panel has been also spread to a wide touch screen. When a touch panel is used in a PDA, a fine electrode pattern is required to obtain a fine screen and to improve the accuracy of fine coordinates. As this fine electrode pattern is required, the sensitivity of a touch panel may deteriorate due to an influence of adjacent electrodes. A touch panel used in a wide screen requires a large number of pattern electrodes due to the wide screen. Thus, various problems occur. For example, a line width of a bezel is increased, an integrated circuit (IC) with a high capacity is required, and power consumption is increased.

### SUMMARY OF THE INVENTION

The present invention has been made in an effort to provide a touch panel that has improved sensitivity or has a wide touch area of a wide screen by simply using a small number of electrode patterns by structurally modifying electrodes of the touch panel, according to a device or the like in which the touch panel is used.

According to a first preferred embodiment of the present invention, there is provided a touch panel including: a lower transparent substrate including concave portions and convex portions that are consecutively formed; a lower detecting electrode that is consecutively formed on lower transparent substrate in one direction so as to correspond to the concave portions and the convex portions; an upper transparent substrate including convex portions and concave portions that are reciprocally formed with the concave portions and the convex portions of the lower transparent substrate; and an upper detecting electrode that is formed on the upper transparent substrate in one direction in which the convex portions of the upper transparent substrate are formed to correspond to the concave portions on which the lower detecting electrode is formed.

The concave portions and the convex portions may have “ [symbol] ” and “ [symbol] ” shapes, respectively.

The upper detecting electrode may be formed as a sensing electrode on which a touch of the touch panel is performed, and the lower detecting electrode may be formed as a driving electrode.

The lower detecting electrode may be formed in one direction in which the concave portions and the convex portions of the lower transparent substrate are formed, and the upper detecting electrode may be formed in one direction in which the convex portions of the upper transparent substrate are formed perpendicular to one direction in which the lower detecting electrode is formed.

The upper transparent substrate and the lower transparent substrate may be adhered to each other such that the upper detecting electrode and the lower detecting electrode face each other, and a transparent adhesive layer may be further formed between adhesive surfaces of the upper transparent substrate and the lower transparent substrate.

The transparent adhesive layer may use optical clear adhesive (OCA) or ultraviolet (UV) resin.

According to another preferred embodiment of the present invention, there is provided a touch panel, including: a lower transparent substrate including concave portions and convex portions that are consecutively formed; a lower detecting electrode that is consecutively formed on lower transparent substrate in one direction so as to correspond to the concave portions and the convex portions; an upper transparent substrate including convex portions and concave portions that are reciprocally formed with the concave portions and the convex portions of the lower transparent substrate; and an upper detecting electrode that is formed on the upper transparent substrate in one direction in which the concave portions of the upper transparent substrate are formed to correspond to the convex portions on which the lower detecting electrode is formed.

The concave portions and the convex portions may have “ [symbol] ” and “ [symbol] ” shapes, respectively.

The upper detecting electrode may be formed as a sensing electrode on which a touch of the touch panel is performed, and the lower detecting electrode may be formed as a driving electrode.

The lower detecting electrode may be formed in one direction in which the concave portions and the convex portions of the lower transparent substrate are formed, and the upper detecting electrode may be formed in one direction in which the concave portions of the upper transparent substrate are formed perpendicular to one direction in which the lower detecting electrode is formed.

The upper transparent substrate and the lower transparent substrate may be adhered to each other such that the upper detecting electrode and the lower detecting electrode face each other, and a transparent adhesive layer may be further formed between adhesive surfaces of the upper transparent substrate and the lower transparent substrate.

The transparent adhesive layer may use optical clear adhesive (OCA) or ultraviolet (UV) resin.

### BRIEF DESCRIPTION OF THE DRAWINGS

FIG. 1 is an exploded perspective view of an upper detecting electrode and a lower detecting electrode of a touch panel according to an embodiment of the present invention;

FIG. 2 is a cross-sectional view of the touch panel of FIG. 1, according to an embodiment of the present invention;

FIG. 3 is an enlarged cross-sectional view for illustrating a distribution of an electric field of the upper detecting electrode and the lower detecting electrode of the touch panel of FIG. 1, according to an embodiment of the present invention;

FIG. 4 is an exploded perspective view of an upper detecting electrode and a lower detecting electrode of a touch panel according to another embodiment of the present invention;

FIG. 5 is a cross-sectional view of the touch panel of FIG. 4, according to another embodiment of the present invention; and

FIG. 6 is an enlarged cross-sectional view for illustrating a distribution of an electric field of the upper detecting electrode and the lower detecting electrode of the touch panel of FIG. 4, according to another embodiment of the present invention.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. The terms such as “one surface”, “the other surface”, “first”, and “second” are used only for the purpose of distinguishing one constituent element from another constituent element, but the constituent elements are not limited by the terms. In addition, with regard to the terms such as “concave” and “convex” of “concave portion” and “convex portion”, a portion protrudes toward a space formed between an upper transparent substrate and a lower transparent substrate that face each other is referred to as the “convex portion” and a portion that is formed outward from the space is referred to as the “concave portion”. Further, when it is determined that the detailed description of the known art related to the present invention may obscure the gist of the present invention, the detailed description thereof will be omitted.

Hereinafter, the present invention will be described in detail by explaining exemplary embodiments of the invention with reference to the attached drawings.

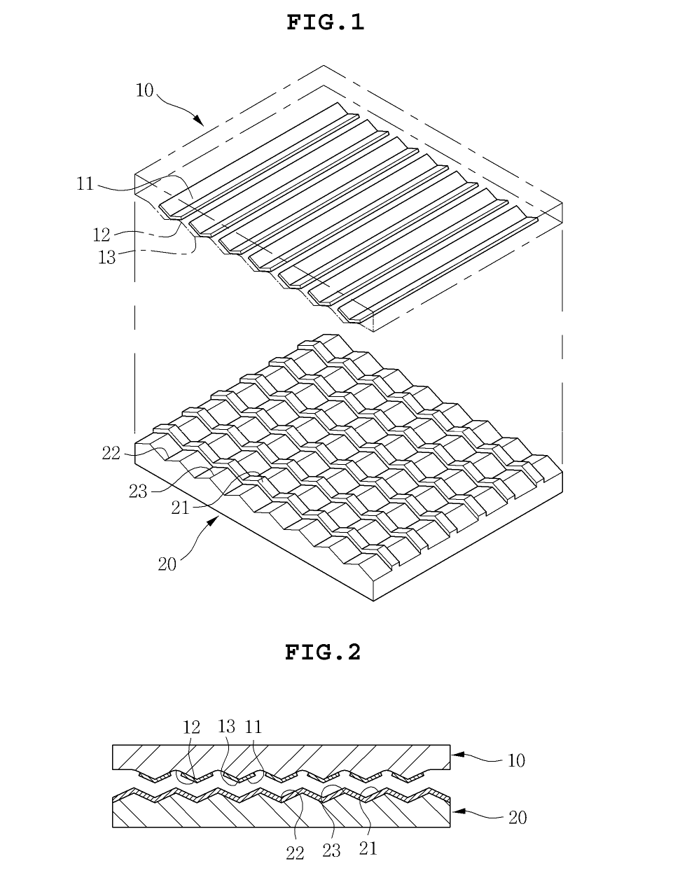

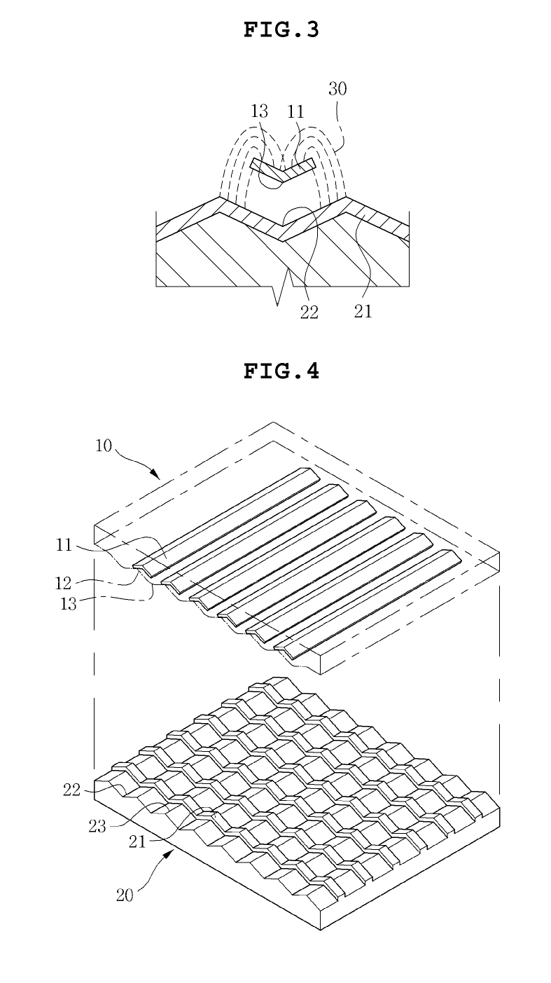

FIG. 1 is an exploded perspective view of an upper detecting electrode 11 and a lower detecting electrode 21 of a touch panel according to an embodiment of the present invention. FIG. 2 is a cross-sectional view of the touch panel of FIG. 1, according to an embodiment of the present invention. FIG. 3 is an enlarged cross-sectional view for illustrating a distribution of an electric field 30 of the upper detecting electrode 11 and the lower detecting electrode 21 of the touch panel of FIG. 1, according to an embodiment of the present invention.

The touch panel according to the present embodiment includes a lower transparent substrate 20 including concave portions 22 and convex portions 23 that are consecutively formed, the lower detecting electrode 21 that is consecutively formed on the lower transparent substrate 20 in one direction so as to correspond to the concave portions 22 and the convex portions 23, an upper transparent substrate 10 including convex portions 13 and concave portions 12 that are reciprocally formed with the concave portions 22 and the convex portions 23 of the lower transparent substrate 20, and the upper detecting electrode 11 that is formed on the upper transparent substrate 10 in one direction in which the convex portions 13 of the upper transparent substrate 10 are formed to correspond to the concave portions 22 on which the lower detecting electrode 21 is formed.

The lower transparent substrate 20 includes the concave portions 22 and the convex portions 23 that are consecutively formed. The lower transparent substrate 20 itself may be formed to be uneven. Alternatively, an uneven portion including the concave portions 22 and the convex portions 23 may be formed on a surface of the lower transparent substrate 20, on which the lower detecting electrode 21 is formed. The concave portions 22 and the convex portions 23, which correspond to a structural shape of the lower transparent substrate 20, may have “ [symbol] ” and “ [symbol] ” shapes, respectively. In addition, those skilled in the art will select and use any structure having similar shapes to the “ [symbol] ” and “ [symbol] ” shapes as long as the structure may concentrate the distribution of the electric field 30 that will be described below. In addition, the structure of the lower transparent substrate 20 is formed to obtain the structure of the lower detecting electrode 21, which is formed on one surface of the lower transparent substrate 20. Thus, it is sufficient to form the structure of the lower transparent substrate 20 on only one surface of the lower transparent substrate 20, on which the lower detecting electrode 21 is formed.

The lower transparent substrate 20 may be formed of, but is not limited to, any material having a predetermined intensity or more, for example, polyethyleneterephthalate (PET), polycarbonate (PC), polymethyl methacrylate (PMMA), polyethylenenaphthalate (PEN), polyethersulfone (PES), cyclic olefin copolymer (COC), a triacetylcellulose (TAC) film, a polyvinyl alcohol (PVA) film, a polyimide (PI) film, polystyrene (PS), K resin-containing biaxially oriented polystyrene (BOPS), glass, tempered glass, or the like. Since the lower detecting electrode 21 is formed on a surface of the lower transparent substrate 20, a surface processing layer may be formed on the surface of the lower transparent substrate 20 by performing high-frequency treatment, primer treatment, or the like on the surface of the lower transparent substrate 20 in order to increase adhesion between the lower transparent substrate 20 and the lower detecting electrode 21.

The lower detecting electrode 21 may be formed on the lower transparent substrate 20 and may be formed in one direction in which the concave portions 22 and the convex portions 23 of the lower transparent substrate 20 are formed. The lower detecting electrode 21 may use a transparent electrode or a metal mesh electrode. In particular, when the upper detecting electrode 11 functions as a sensing electrode that will be described below, the lower detecting electrode 21 may be formed so as to function as a relative driving electrode. When a current is supplied to the lower detecting electrode 21, the electric field 30 is formed in the upper detecting electrode 11 that functions as a sensing electrode that is formed at an upper portion of the touch panel. In this case, by structurally modifying the lower detecting electrode 21 that is capable of functioning as a driving electrode and the upper detecting electrode 11 that is capable of functioning as a sensing electrode, the electric field 30 may be formed to be concentrated on a sensing region that is touched without any influence of adjacent electrode patterns.

In this case, the transparent electrode may be formed of a conductive polymer, in particular, poly-3,4-ethylenedioxythiophene/polystyrenesulfonate (PEDOT/PSS), polyaniline, polyacetylene, polyphenylenevinylene, or the like. In addition, indium tin oxide (ITO), carbon nanotube as an organic transparent electrode material, graphene, zinc oxide (ZnO), tin oxide (SnO₂), or the like may be used to form the transparent electrode. Also, it will be obvious that other transparent electrodes formed of various materials are selected and modified by those skilled in the art. The transparent electrode may be formed on the lower transparent substrate 20 by using, but is not limited to, a physical method such as a sputtering method, a vacuum deposition method, an ion plating method, or the like, or a chemical method such as a spray method, a dip method, a chemical vapor deposition (CVD) method, or the like.

The metal mesh electrode may be formed by spinning a spinning solution on the lower transparent substrate 20 by using an electrospinning method. The spinning solution may be obtained by dispersing metal, metal oxide, conductive polymer, carbon nanotube, graphene, or a combination thereof in a solvent by using a binder. In detail, the metal may include copper (Cu), aluminum (Al), gold (Au), silver (Ag), titanium (Ti), palladium (Pd), chrome (Cr), or a combination thereof. The metal oxide may include indium tin oxide (ITO), antimony tin oxide (ATO), aluminum zinc oxide (AZO), or a combination thereof. The conductive polymer may include the above-exemplified materials. Other methods of forming the metal mesh electrode by using the electrospinning method are general methods and thus their detailed description will be omitted. Also, the metal mesh electrode may be formed by using various methods other than the electrospinning method. The detailed description of known methods will be omitted.

The convex portions 13 and the concave portions 12 of the upper transparent substrate 10 may be reciprocally formed with the concave portions 22 and the convex portions 23 of the lower transparent substrate 20, respectively. A surface of the upper transparent substrate 10, on which the upper detecting electrode 11 is formed, may be formed to have an uneven portion including the concave portions 12 and the convex portions 13. The concave portions 12 and the convex portions 13, which correspond to a structural shape of the upper transparent substrate 10, may have “ [symbol] ” and “ [symbol] ” shapes, respectively. In addition, those skilled in the art will select and use any structure having similar shapes to the “ [symbol] ” and “ [symbol] ” shapes as long as the structure may concentrate the distribution of the electric field 30 that will be described below. The type of material and properties of the upper transparent substrate 10 are the same as the above-described material and properties of the lower transparent substrate 20, and thus their detailed description will not be repeated.

The upper detecting electrode 11 generates a signal when a user touches the touch panel and allows a controller (not shown) to recognize a coordinate, and is formed on a surface of the upper transparent substrate 10. In detail, the upper detecting electrode 11 is formed on the upper transparent substrate 10 in one direction in which the convex portions 13 of the upper transparent substrate 10 are formed to correspond to the concave portions 22 on which the lower detecting electrode 21 is formed. The lower detecting electrode 21 and the upper detecting electrode 11 may extend in directions perpendicular to each other so as to cross each other so that a coordinate with X and Y axes is obtained, thereby detecting a sensing position or the like. According to the present embodiment, the upper detecting electrode 11 may be formed on a surface of the touch panel, which is directly touched by the user, and may serve as a sensing electrode.

In particular, improved touch sensitivity may be maintained in the same touch region by using structural properties obtained by combining the upper detecting electrode 11 and the lower detecting electrode 21. As shown in FIG. 2, the lower detecting electrode 21 may be formed in one direction in which the concave portions 22 and the convex portions 23 of the lower transparent substrate 20 are formed. The upper detecting electrode 11 may be formed in one direction in which the convex portions 13 of the upper transparent substrate 10 are formed perpendicular to one direction in which the lower detecting electrode 21 is formed.

As a result, as shown in FIG. 3, the upper detecting electrode 11 is formed along surfaces of the convex portions 13 of the upper transparent substrate 10. The lower detecting electrode 21 is formed in one direction in which the concave portions 22 and the convex portions 23 of the lower transparent substrate 20 are formed so as to cross the upper detecting electrode 11. Due to this structure, the touch panel may be configured such that the electric field 30 generated by supplying a current from the lower detecting electrode 21 may be concentrated on the upper detecting electrode 11. By using a distribution of the electric field 30 concentrated on the upper detecting electrode 11, the touch sensitivity of the upper detecting electrode 11 functioning as a sensing electrode may be further improved. In addition, the touch panel may be configured such that the electric field 30 generated in the concave portions 22 of the lower detecting electrode 21, which have a “ [symbol] ” shape, is deflected toward a central portion of the upper detecting electrode 11. Thus, interference with adjacent electrode patterns may be minimized, thereby reducing noise generated when the touch panel is touched and improving the reliability of a touch operation.

With regard to a final structure, the upper transparent substrate 10 and the lower transparent substrate 20 may be adhered to each other by a transparent adhesive layer. The upper transparent substrate 10 and the lower transparent substrate 20 may be adhered to each other such that the upper detecting electrode 11 formed on the upper transparent substrate 10 and the lower detecting electrode 21 formed on the lower transparent substrate 20 may face each other, the upper detecting electrode 11 that is formed along the surfaces of the convex portions 13 of the upper transparent substrate 10 in one direction may cross the lower detecting electrode 21 that is formed on the concave portions 22 and the convex portions 23 of the lower transparent substrate 20 in one direction, and the surfaces of the convex portions 13 on which the upper detecting electrode 11 is formed and the surfaces of the concave portions 22 on which the lower detecting electrode 21 is formed may face each other, as described above. In addition, although not illustrated, it will be appreciated by those skilled in the art that, when the upper detecting electrode 11 serves as a sensing electrode, it will be appreciated by those skilled in the art that a transparent protective layer (not shown) or a window board (not shown) may be further formed on the upper detecting electrode 11, as such would be a nominal design change.

In this case, the transparent adhesive layer for adhering the upper transparent substrate 10 and the lower transparent substrate 20 to each other may use optical clear adhesive (OCA) or ultraviolet (UV) resin. In particular, the UV resin may also be referred to as UV curable resin that refers to resin that is a polymer in a solid state obtained by irradiating UV rays to a UV curable resin material. In this case, a chemical change occurs. In detail, in the chemical change, a resin, UV adhesive having photosensitivity, UV coating resin, UV ink, or the like, which is changed to a monomer or oligomer when UV rays emitted from a UV lamp are irradiated thereto and a photo initiator begins to react, is briefly cured due to photopolymerization that occurs thereon. When UV resin is used, it takes several seconds to cure the UV resin, thereby obtaining high productivity. In addition, an operation may be performed also in a narrow space due to compact equipment. In addition, high intensity, high reinforcement performance, high sensitivity, solvent resistance, chemical resistance, pollution resistance, rub resistance, or the like may be obtained. An adhesive agent for adhering the upper transparent substrate 10 and the lower transparent substrate 20 is not limited to these materials. Thus, those skilled in the art will select and use various adhesive agents.

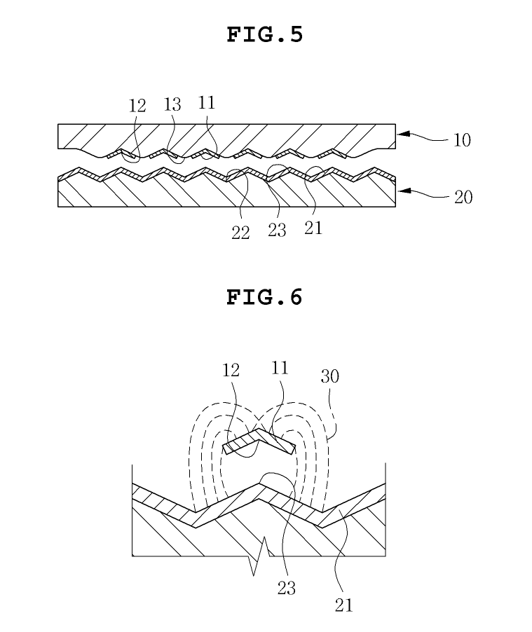

FIG. 4 is an exploded perspective view of an upper detecting electrode 11 and a lower detecting electrode 21 of a touch panel according to another embodiment of the present invention. FIG. 5 is a cross-sectional view of the touch panel of FIG. 4, according to another embodiment of the present invention. FIG. 6 is an enlarged cross-sectional view for illustrating a distribution of an electric field 30 of the upper detecting electrode 11 and the lower detecting electrode 21 of the touch panel of FIG. 4, according to another embodiment of the present invention.

The touch panel according to the present embodiment includes a lower transparent substrate 20 including concave portions 22 and convex portions 23 that are consecutively formed, the lower detecting electrode 21 that is consecutively formed on the lower transparent substrate 20 in one direction so as to correspond to the concave portions 22 and the convex portions 23, an upper transparent substrate 10 including convex portions 13 and concave portions 12 that are reciprocally formed with the concave portions 22 and the convex portions 23 of the lower transparent substrate 20, and the upper detecting electrode 11 that is formed on the upper transparent substrate 10 in one direction in which the concave portions 12 of the upper transparent substrate 10 are formed to correspond to the convex portions 23 on which the lower detecting electrode 21 is formed.

The upper transparent substrate 10, the lower transparent substrate 20, the upper detecting electrode 11, the lower detecting electrode 21, and the transparent adhesive layer of FIGS. 4, 5, and 6 have similar properties and functions to those of FIGS. 1, 2, and 3 and thus their detailed description will be repeated.

The touch panel according to the present embodiment is used in a wide screen and is obtained by structurally modifying the upper detecting electrode 11 and the lower detecting electrode 21 so as to extend a sensing range of a touch, compared with the touch panel shown in FIGS. 1, 2, and 3.

Hereinafter, components of the touch panel according to the present embodiment will be described in terms of their functions and effects.

The lower transparent substrate 20 includes the concave portions 22 and the convex portions 23 that are consecutively formed. The lower transparent substrate 20 itself may be formed to be uneven. Alternatively, an uneven portion including the concave portions 22 and the convex portions 23 may be formed on a surface of the lower transparent substrate 20, on which the lower detecting electrode 21 is formed. The concave portions 22 and the convex portions 23, which correspond to a structural shape of the lower transparent substrate 20, may have “ [symbol] ” and “ [symbol] ” shapes, respectively. In addition, those skilled in the art will select and use any structure having similar shapes to the “ [symbol] ” and “ [symbol] ” shapes as long as the structure may concentrate the distribution of the electric field 30 that will be described below. In addition, the structure of the lower transparent substrate 20 is formed to obtain the structure of the lower detecting electrode 21, which is formed on one surface of the lower transparent substrate 20. Thus, it is sufficient to form the structure of the lower transparent substrate 20 on only one surface of the lower transparent substrate 20, on which the lower detecting electrode 21 is formed.

The lower detecting electrode 21 may be formed on the lower transparent substrate 20 and may be formed in one direction in which the concave portions 22 and the convex portions 23 of the lower transparent substrate 20 are formed. The lower detecting electrode 21 may use a transparent electrode or a metal mesh electrode. In particular, the lower detecting electrode 21 may be formed as a driving electrode so that the upper detecting electrode 11 is formed as a sensing electrode that will be described below. When a current is supplied to the lower detecting electrode 21, the electric field 30 is formed in the sensing electrode that is formed at an upper portion of the touch panel. In this case, by structurally modifying the lower detecting electrode 21 that is capable of functioning as a driving electrode and the upper detecting electrode 11 that is capable of functioning as a sensing electrode, the distribution of the electric field 30 extends outward, thereby extending a sensing range of a touch without changing an electrode pattern, which will be described below in more detail.

The convex portions 13 and the concave portions 12 of the upper transparent substrate 10 may be reciprocally formed with the concave portions 22 and the convex portions 23 of the lower transparent substrate 20, respectively. A surface of the upper transparent substrate 10, on which the upper detecting electrode 11 is formed, may be formed to have an uneven portion including the concave portions 12 and the convex portions 13. The concave portions 12 and the convex portions 13, which correspond to a structural shape of the upper transparent substrate 10, may have “ [symbol] ” and “ [symbol] ” shapes, respectively. In addition, the structure of the upper transparent substrate 10 is formed to obtain the structure of the upper detecting electrode 11, which is formed on one surface of the upper transparent substrate 10. Thus, it is sufficient to form the structure of the upper transparent substrate 10 on only one surface of the upper transparent substrate 10, on which the upper detecting electrode 11 is formed.

The upper detecting electrode 11 is formed on the upper transparent substrate 10 in one direction in which the concave portions 12 of the upper transparent substrate 10 are formed to correspond to the convex portions 23 on which the lower detecting electrode 21 is formed. That is, the lower detecting electrode 21 may be formed in one direction in which the concave portions 22 and the convex portions 23 of the lower transparent substrate 20 are formed. In addition, the upper detecting electrode 11 may be formed in one direction in which the concave portions 12 of the upper transparent substrate 10 are formed perpendicular to one direction in which the lower detecting electrode 21 is formed.

The upper detecting electrode 11 may be formed as a transparent electrode or a metal mesh electrode, as described with reference to FIGS. 1, 2, and 3. In addition, other details may not be repeated.

Unlike in FIGS. 1, 2, and 3, the upper detecting electrode 11 may be formed along surfaces of the concave portions 12 of the upper transparent substrate 10 in one direction so as to correspond to the convex portions 23 on which the lower detecting electrode 21 is formed, as shown in FIG. 5. When the upper detecting electrode 11 serves as a sensing electrode and the lower detecting electrode 21 severs as a driving electrode, the distribution of the electric field 30 are different from the electric field 30 shown in FIG. 3 (refer to FIG. 6). As shown in FIG. 6, when a driving current is supplied to the lower detecting electrode 21, the electric field 30 may have an imaginary shape constituting lines that detours outward and enters the upper detecting electrode 11 as a sensing electrode through the convex portions 23 of the lower detecting electrode 21, which have a “ [symbol] ” shape. Thus, unlike a general parallel electrode structure, a portion of the electric field 30 is also formed to exceed an electrode pattern, and thus a sensing range of a touch of the upper detecting electrode 11 constituting a sensing portion may be extended. Thus, when the touch panel is used in a wide screen or the like, a wide sensing region may be obtained in spite of limited electrode patterns, and the number of electrode patterns is not increased, thereby reducing power consumption. As the distribution of the electric field 30 is widened, since the number of electric fields 30 is not reduced and the electric field 30 is not weakened, the widened distribution of the electric field 30 does not affect the sensitivity of the touch panel.

With regard to a final structure, the upper transparent substrate 10 and the lower transparent substrate 20 may be adhered to each other by a transparent adhesive layer. The upper transparent substrate 10 and the lower transparent substrate 20 may be adhered to each other such that the upper detecting electrode 11 formed on the upper transparent substrate 10 and the lower detecting electrode 21 formed on the lower transparent substrate 20 may face each other, the upper detecting electrode 11 that is formed along the surfaces of the concave portions 12 of the upper transparent substrate 10 in one direction may cross the lower detecting electrode 21 that is formed on the concave portions 22 and the convex portions 23 of the lower transparent substrate 20 in one direction, and the surfaces of the concave portions 12 on which the upper detecting electrode 11 is formed and the surfaces of the convex portions 23 on which the lower detecting electrode 21 is formed may face each other, as described above. In addition, although not illustrated, it will be appreciated by those skilled in the art that, when the upper detecting electrode 11 serves as a sensing electrode, a transparent protective layer (not shown) or a window board (not shown) may be further formed on the upper detecting electrode 11, as such would be a nominal design change.

In this case, the transparent adhesive layer for adhering the upper transparent substrate 10 and the lower transparent substrate 20 to each other may use optical clear adhesive (OCA) or ultraviolet (UV) resin. Other details are the same as in FIGS. 1, 2, and 3, and thus will not be repeated.

In the touch panel according to an embodiment of the present invention, a distribution of an electric field concentrated on a sensing electrode, thereby improving the sensitivity of the touch panel, compared with a general electrode structure.

Due to the distribution of the electric field that concentrated on the sensing electrode, interference with adjacent electrodes may be minimized.

Interference with adjacent electrodes is minimized in the sensing electrode of the touch panel, thereby ensuring the driving reliability of the touch panel.

In addition, in the touch panel according to another embodiment of the present invention, a distribution of an electric field is generated in a wide space, thereby extending a sensing range of the touch panel, compared with a general electrode structure.

A touch area with a wide range may be obtained without changing an electrode pattern.

A touch area with a wide range is obtained without changing an electrode pattern, thereby reducing a line width of a bezel and reducing power consumption.

Although the preferred embodiments of the present invention have been disclosed for illustrative purposes, they are for specifically explaining the present invention. Therefore, a touch panel according to the preferred embodiments of the present invention is not limited thereto, but those skilled in the art will appreciate that various modifications and alteration are possible, without departing from the scope and spirit of the invention as disclosed in the accompanying claims.

Accordingly, such modifications and alterations should also be understood to fall within the scope of the present invention. A specific protective scope of the present invention could be defined by accompanying claims.

What is claimed is:

1. A touch panel, comprising:
a lower transparent substrate including concave portions and convex portions that are consecutively formed;
a lower detecting electrode that is consecutively formed on lower transparent substrate in one direction so as to correspond to the concave portions and the convex portions;
an upper transparent substrate including convex portions and concave portions that are reciprocally formed with the concave portions and the convex portions of the lower transparent substrate; and
an upper detecting electrode that is formed on the upper transparent substrate in one direction in which the convex portions of the upper transparent substrate are formed to correspond to the concave portions on which the lower detecting electrode is formed.

2. The touch panel as set forth in claim 1, wherein the concave portions and the convex portions have “ [symbol] ” and “ [symbol] ” shapes, respectively.

3. The touch panel as set forth in claim 1, wherein the upper detecting electrode is formed as a sensing electrode on which a touch of the touch panel is performed, and the lower detecting electrode is formed as a driving electrode.

4. The touch panel as set forth in claim 1, wherein the lower detecting electrode is formed in one direction in which the concave portions and the convex portions of the lower transparent substrate are formed, and the upper detecting electrode is formed in one direction in which the convex portions of the upper transparent substrate are formed perpendicular to one direction in which the lower detecting electrode is formed.

5. The touch panel as set forth in claim 1, wherein the upper transparent substrate and the lower transparent substrate are adhered to each other such that the upper detecting electrode and the lower detecting electrode face each other, and
wherein a transparent adhesive layer is further formed between adhesive surfaces of the upper transparent substrate and the lower transparent substrate.

6. The touch panel as set forth in claim 5, wherein the transparent adhesive layer uses optical clear adhesive (OCA) or ultraviolet (UV) resin.

7. A touch panel, comprising:
a lower transparent substrate including concave portions and convex portions that are consecutively formed;
a lower detecting electrode that is consecutively formed on lower transparent substrate in one direction so as to correspond to the concave portions and the convex portions;
an upper transparent substrate including convex portions and concave portions that are reciprocally formed with the concave portions and the convex portions of the lower transparent substrate; and
an upper detecting electrode that is formed on the upper transparent substrate in one direction in which the concave portions of the upper transparent substrate are formed to correspond to the convex portions on which the lower detecting electrode is formed.

8. The touch panel as set forth in claim 7, wherein the concave portions and the convex portions have “ [symbol] ” and “ [symbol] ” shapes, respectively.

9. The touch panel as set forth in claim 7, wherein the upper detecting electrode is formed as a sensing electrode on which a touch of the touch panel is performed, and the lower detecting electrode is formed as a driving electrode.

10. The touch panel as set forth in claim 7, wherein the lower detecting electrode is formed in one direction in which the concave portions and the convex portions of the lower transparent substrate are formed, and the upper detecting electrode is formed in one direction in which the concave portions of the upper transparent substrate are formed perpendicular to one direction in which the lower detecting electrode is formed.

11. The touch panel as set forth in claim 7, wherein the upper transparent substrate and the lower transparent substrate are adhered to each other such that the upper detecting electrode and the lower detecting electrode face each other, and
wherein a transparent adhesive layer is further formed between adhesive surfaces of the upper transparent substrate and the lower transparent substrate.

12. The touch panel as set forth in claim 11, wherein the transparent adhesive layer uses optical clear adhesive (OCA) or ultraviolet (UV) resin.
